(19) United States
(12) Patent Application Publication
(10) Pub. No.: US 2006/0136739 A1
(43) Pub. Date: Jun. 22, 2006

(54) Method and apparatus for generating one-time password on hand-held mobile device

(76) Inventors: Christian Brock, Severna Park, MD (US); Chaing Chen, Laurel, MD (US)

Correspondence Address: Christian Brock, 1131 Old County Road, Severna Park, MD, 21146, US

(21) Appl. No.: 11/015,839

(22) Filed: Dec. 18, 2004

(51) Int. Cl. H04N 7/16; H04K 1/00; G06F 17/30; H04L 9/00; G06F 7/04; G06K 9/00; H03M 1/68; H04L 9/32

(52) U.S. Cl. 713/184; 726/29

(57) ABSTRACT

According to the invention, a system and an apparatus to use the One-Touch button on a mobile hand-held device to generate one time passwords (OTP) are disclosed. Components of this system comprise: a mobile hand-held device, a built-in One-Touch button on the mobile device, a Global Authentication Server, and an OTP Generation engine installed and ran on the mobile device. The mobile device user only needs to push the One-Touch button and an OTP is generated. The OTP is generated on the mobile device by the OTP generation engine after a secure key exchange process is performed between the remote Global Authentication Server and the mobile device. The mobile device is registered to use online web services that recognize the OTP through the Global Authentication Service. Online web services require that the user enter a combination of the user's known password and OTP for identity assurance. As a result of this invention, users will quickly adopt the two-factor authentication method as a central means to identify themselves.

### FEDERALLY SPONSORED RESEARCH

Not Applicable

### SEQUENCE LISTING OR PROGRAM

Not Applicable

### FIELD OF THE INVENTION

The present invention relates to a method and apparatus for generating a one-time password (OTP) on hand-held mobile communication devices, and more specifically a method for conveniently generating the OTP by pushing a One-Touch button on the mobile device. This One-Touch button approach provides an effective means to broaden authentication capabilities to service general consumers conducting secure web banking, Automated Teller Machines, or other financial transactions through a Global Authentication Service available on the Internet.

### BACKGROUND OF THE INVENTION

The hand-held mobile device has become a popular communication tool worldwide. Furthermore, advanced functions and capabilities are continually being added to mobile devices. Such that a mobile device user can not only use the device for voice communication, but also for data storage, email, messaging, entertainment, camera, and personal organization. More advance features are also emerging for conducting online financial transactions using the mobile device as a credit card to pay bills or to buy goods and subscription services. The advancement of the hand-held device is propelled by both hardware and software technologies. Each new generation of mobile devices greatly increase the CPU speed and memory size enabling even further functionality. The development of the J2ME specification in recent years has created a developer-friendly environment for software developers to write more application code for hand-held devices. This includes the development of code to authenticate users.

Using the hand-held device to generate a OTP is not a new idea. Many companies, such as RSA, VASCO, Swivel, StrikeForce have used the hand-held device to deliver the OTP. However, the procedure to get the OTP is cumbersome and the algorithm to generate the OTP is not secure. The principal object of the invention is to provide a practical approach to generating secure one-time passwords upon a user's demand. As a result, users will quickly adopt the technology as a central means to prove their identity during authentication.

### SUMMARY

The object of this invention is to describe a system that can generate a OTP by pushing a One-Touch button on the hand-held device. The idea came from the need to find a convenient use for two-factor authentication using a mobile hand-held device. This OTP generation is based on the authentication system and method described in the pending patent #20030163694. The OTP is generated on the mobile hand-held device after a secure key exchange process is performed between a remote authentication server and the mobile device. The owner of the mobile device is registered to use the Global Authentication Services that recognize the OTP. The Global Authentication Service requires that the user enter a combination of the user's known password and OTP for identity assurance. It is based on the authentication concept that providing who you are depends on more than one factor. The first factor is based on something you know (password) and the second factor is based on something you have (mobile device).

The One-Touch button is a part of the built-in hardware on the hand-held device. Whenever, there is a need to generate a OTP, the user just pushes the One-Touch button. Behind the scene, after the button is touched, an application code is activated and executed under the hand-held device's Java Virtual Machine. The first step of the code execution is to generate a Diffie-Hellman exchange key. The second step is to open a socket to establish a wireless HTTP connection to a remote authentication server. The third step is to exchange information with server and close the wireless connection. Afterward, a OTP is computed by the hand-held device based on the exchanged information. The last step is to display the OTP on the LCD screen of the hand-held device. The salient features of this approach are:
Providing an easy and simple means for a user to get an OTP,
Employing a secure algorithm to generate OTP by using a Global Authentication Service available on the Internet.
Generating OTP on demand only.

### BRIEF DESCRIPTION OF THE DRAWING

Drawing Figures

FIG. 1 is a schematic diagram showing the architecture of the OTP One-Touch button on a mobile hand-held device.

Reference Numerals in Drawing FIG. 1

10 The Mobile Hand-Held Device

20 One-Touch Button

30 Keypad

40 Display Device

FIG. 2 is a schematic diagram showing the architecture of the OTP Generation mechanism.

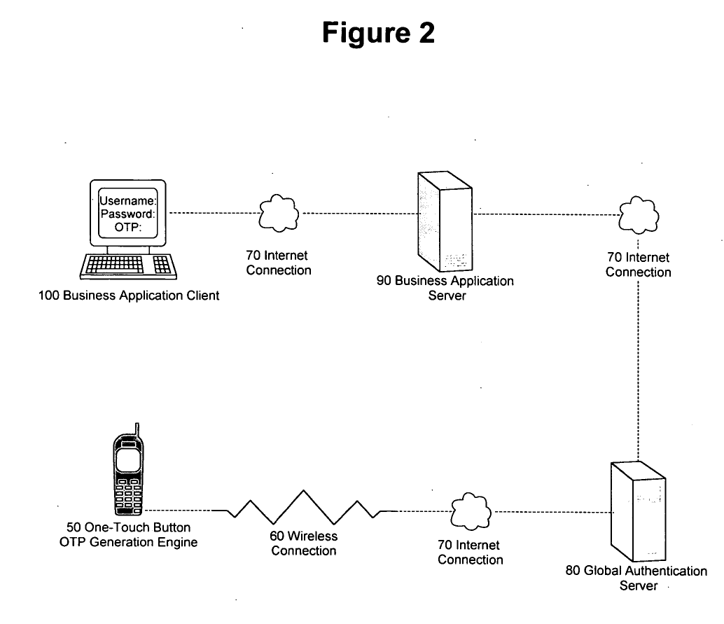

Reference Numerals in Drawing FIG. 2

50 One-Touch Button OTP Generation Engine

60 Wireless Connection

70 Internet Connection

80 Global Authentication Server

90 Business Application Server

100 Business Application Client

### DETAILED DESCRIPTION

In the following, the detailed description is divided into two sections. To simply illustrate what is involved in the One-Touch button, the physical architecture of the mobile device is described in the first section. To further illustrate how the OTP is generated, the logical architecture of its functionality and the associated algorithm are described in the second section. Lastly, because of the slow CPU speed of the hand-held device and the latency of the wireless connection, the detail OTP generation process is depicted in the third section.

One-Touch Button Architecture and its Components

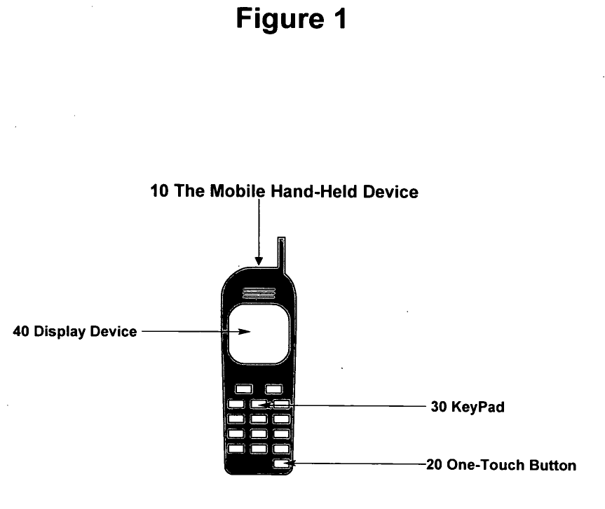

FIG. 1 depicts the One-Touch button architecture. There are four components in this system: the mobile hand-held device 10, the One-Touch button 20 on the mobile device, the keypad 30 and the display device 40.

The One-Touch button improves the mechanism of generating one-time passwords on the mobile device. The OTP is created by committing the single step of pushing one button instead of having to make several keypad entry steps in order for key generation to occur. In addition, it does not require the use of a second device or token to create the OTP. The One-touch button approach allows the consumer to save time and effort during the authentication process while conducting transactions. This simple process makes it very appealing to mobile phone and PDA users who are always moving and busy with travel. They will enjoy the convenience of having a single built-in function displayed on the keypad device that would keep them from having to maintain and carry an extra device that would provide the similar function of generating a OTP.

This One-Touch button approach has been used in some of the hand-held devices. For example, Sony-Ericsson T637 has the One-Touch button to access the Internet Online service. However, the use of the One-Touch button to access the global authentication service is new and is presented by this invention. The following sections describe the procedure how the One-Touch button links to the generation of One-Time Passwords.

OTP Generation Architecture

FIG. 2 depicts the OTP generation architecture. There are also four components in this system: the mobile hand-held device that contains the OTP Generation Engine, Business Application Engine, the One-Touch button, and the Global Authentication Server. The sequence of events to generate the OTP and its usage is described as the following.
1. User pushes the One-Touch button 50.
2. When the One-Touch button is pushed, the OTP Generation Engine is activated.
3. The OTP Generation Engine initiates a wireless socket connection to the Global Authentication Server 80.
4. Information for key exchange is composed by the OTP Generation Engine and subsequently sent to the Global Authentication Server.
5. Global Authentication Server receives the key exchange information and generates response information sent back to the OTP Generation Engine.
6. The OTP Generation Engine receives the response information and uses it to generate the OTP.
7. The OTP is displayed on the LCD screen.
8. The user enters the OTP on the Business Application Client 100 login page that is served by the Business Application Server 90.
   OTP Generation Methods

The OTP Generation Engine is a code written in the “C” or Java programming language that runs on the mobile hand-held device. Functions of this code are summarized as the following.
1. Establish Socket Connection—opens a TCP/IP connection to the Global Authentication Server.
2. Generate Key Exchange Information—uses Diffie-Hellman type of algorithm to compute the secret information without transmitting it over the wireless network.
3. Data Encryption—provides extra security by encrypting all data transmitted over the wireless network. During the encryption, a session key is generated and used.
4. OTP Generation—generates OTP based on the exchange key information plus additional shared secret information that is already stored on the Global Authentication Server and the hand-held device.
   Global Authentication Service

The Global Authentication Server is a portal server that resides on the Internet to offer global authentication portal services. The details are described in the pending patent #20030163694. The main idea of pairing the Global Authentication Server with the mobile hand-held device is to enable users to conveniently use a single hand-held device to generate a OTP as an identifier used for authenticating themselves to a variety of businesses providing Online web services, or other financial transactions including ATM banking. The following list describes the main features of the Global Authentication Server.
1. It offers a Global Authentication Service over the Internet.
2. It uses a Web Service concept to provide authentication service.
3. It contains minimum and encrypted information to authenticate a user.
4. Data communication with the Global Authentication Server is encrypted.

The simplicity of the One-Touch button/Global Authentication service approach can greatly transform the industry regarding user authentication and identity management. The practical use of this system has broad implications. The user who takes advantage of the convenient One-Touch button/Global Authentication Service on a hand-held mobile device can securely logon to several web sites that offer two-factor identification including: access to an online bank, the purchase of goods from an online merchant, or verify credentials in order to withdraw cash from an ATM. The rapid growth of the Internet for consumer use has made two-factor authentication a necessary measure of identity assurance for financial transactions. Currently, the majority of online web sites only require single-factor authentication, i.e., an account name, and a static password to logon. Passwords are meant to be kept in secret at all times. Yet, passwords are difficult to keep secret. Security breaches involving stolen identities occur frequently and are increasing at disturbing rate. Even using the secure HTTPS communication protocol, which encrypts the password as it travels over the Internet, does not protect a user's identity due to sophisticated trickery in malicious software that a thief can use to capture all of the user's keystrokes including account name, password, and PIN number. The consumer has a high potential of becoming a victim of fraud and could suffer huge financial losses as a result. The need to protect both the consumer and the merchant from fraud is the driving force for the wide acceptance of the One-Touch button/Global Authentication Service to provide identity assurance.

OTP Generation Process Implemented on the Wireless Mobile Hand-Held Device

Because of the slow CPU speed of the hand-held device and the latency of the wireless connection, a special process is developed to shorten the time span to generate a OTP on the wireless hand-held device. This process is divided into two parts, i.e., synchronization and OTP generation. Although the synchronization is a slow process, it establishes a strong security foundation for the faster OTP generation process. Furthermore, a procedure is developed for the OTP generation when there is no wireless connection. The following is the detail description of the synchronization and OTP generation process.

I) Synchronization Process:

The main purpose of the synchronization process is to generate a session key and a shared secret information between the global authentication server and the wireless mobile hand-held device. The session key is used to encrypted the HTTP request and response messages when the OTP generation process is executed by the mobile device. The secret information is used for the OTP generation process to generated OTPs. The following is a summary of the session key generation and the shared secret information generation processes.

i) Master Session Key Generation Process:

1. The hand-held device generates a random integer number XA1.

2. The hand-held device computes a variable YA1=GˆXA1 mod P, where G is a base integer number and P is the modulus.

3. The hand-held device opens a HTTP session ant transmits YA1 to the global authentication server.

4. The global authentication server generates a random integer number XB1 and computes a variable YB1=GˆXB1 mod P.

5. The server generates a HTTP session ID.

6. The server transmits the variable YB1 and the HTTP session ID to the hand-held device.

7. The hand-held device receives YB1 and the session ID.

8. The hand-held device computes the master session key KA1 by KA1=YB1ˆXA1 mod P.

9. The global authentication server also computes a master session key KB1=YA1ˆXB1 mod P. The session key KA1 should be the same as KB1.

ii) Shared Secret Information Generation Process:

1. The hand-held device generates another random integer number XA2 and computes YA2=GˆXA2.

2. The hand-held device generate another random number skeypass as the password to encrypt the session key KA1.

3. The hand-held device composes a HTTP request message which consists of user name, user password, YA2 and skeypass.

4. The hand-held device encrypts this HTTP request message by the session key KA1.

5. The hand-held device transmits the encrypted HTTP request message and the session ID information to the global authentication server.

6. The global authentication server receives the encrypted HTTP request message and use the session key KB1 to decrypt.

7. The global authentication server authenticates the user by verifying user name and password information from the LDAP.

8. The global authentication server generate a random integer number XB2 and computes YB2=GˆXB2 mod P.

9. The global authentication server uses the session key KB1 to encrypt YB2 and transmits the encrypted YB2 to the hand-held device.

10. The hand-held device receives the encrypted YB2 and use the session key KA1 to decrypt.

11. The hand-held device computes the shared secret information by KA2=YB2ˆXA2 mod P.

12. The global authentication server computes the shared secret information by KB2=YA2ˆXB2 mod P.

13. The global authentication server encrypts the session key and the shared secret information using the sesspass.

14. The global authentication server saves the encrypted session key and the shared information at its storage device.

15. The hand-held device encrypts the session key and the shared secret information using user's password.

16. The hand-held device saves the encrypted session key and the shared information at its storage device.

II) OTP Generation Process When There is a Wireless Connection:

The OTP generation process when there is a wireless connection consists of two steps, i.e., session key generation and OTP generation.

i) Session Key Generation:

1. The hand-held device generates a random integer number XA3 and YA3=GˆXA3 mod P.

2. The hand-held device computes a session key KA3=YB3ˆXA3 mod P, where YB3 is a known server key.

ii) OTP Generation:

1. The hand-held device composes a message (m3) which consists of user name and skeypass (session key password).

2. The hand-held device encrypts this message by KA3.

3. The hand-held device composes a HTTP request message which consists of YA3 and encrypted m3.

4. The hand-held device transmits this HTTP message to the global authentication server.

5. The global authentication server receives the HTTP message and computes a session key KB3=YA3ˆXB3 mod P, where XB3 is a pre-generated random number and the known server key is a pre-computed key YB3=GˆXB3 mod P. The session key KB3 should be the same as KA3 computed on the hand-held device.

6. The global authentication server uses KB3 to decrypt and recover user name and skeypass information.

7. The global authentication server reads the encrypted master session key KB1 and the encrypted shared secret information from the LDAP.

8. The global authentication server uses skeypass to decrypt and recovers KB1 and the shared secret information.

9. The global authentication server generates a random number YB4.

10. The global authentication server generates an OTP by key hashing the shared key information using YB4 as the key.

11. The global authentication server generates a verify key by key hashing the token ID using the OTP as the key.

12. The global authentication server saves the verify key in the LDAP.

13. The global authentication server saves YB4 in the LDAP.

14. The global authentication server generates a current time information (T1).

15. The global authentication server composes a message which consists of YB4 and T1.

16. The global authentication server uses the master session key KB1 and KB3 to encrypt this YB4+T1 message.

17. The global authentication transmits the encrypted message to the hand-held device.

18. The hand-held device decrypts the message by KA1 and KA3 to recover YB4 and T1.

19. The hand-held device uses T1 to compute the off-set time (DT1) between the global authentication server and the hand-held device.

20. The hand-held device computes DT1+YB4 and saves in the storage device. This DT1+YB4 information is going to be used to generate an OTP when there is no wireless connection.

21. The hand-held device generates an OTP by key hashing the shared secret information using YB4 as the key.

22. The hand-held device further computes this OTP by OTP=OTP+TokenID.

23. The hand-held device displays this OTP. 2

4. The user uses this resulting OTP to login business application site.

III) OTP Generation Process When there is NO Wireless Connection

1. The hand-held device obtains a current time (T2) information.

2. The hand-held device computes the server time by adding T2 to DT1, i.e., T3=T2+DT1.

3. The hand-held device further computes the server time by T3=T3+YB4.

4. The hand-held device generates an OTP by key hashing the TokenID using T3 as the key.

5. The hand-held device further computes this OTP by OTP=OTP+TokenID.

6. The hand-held device displays this OTP.

What is claimed is:

1. A method and apparatus to generate one time passwords using a One-Touch button approach, comprising:
(a) Mobile hand-held device means to serve as a platform to generate a one-time password (OTP),
(b) Global Authentication Server means to serve as a portal for providing global authentication service,
(c) One-Touch button means on the said mobile hand-held device means to serve as an access point for user to generate OTP,
(d) OTP generation means that runs on the said mobile hand-held device means to serve as the OTP generation engine to generate OTP.

2. The method and apparatus of claim 1 wherein said One-Touch button means contain means to activate and execute the said OTP generation means to produce OTP.

3. The method and apparatus of claim 1 wherein said mobile hand-held device means contain means to be incorporated in a mobile cell phones, PDAs and Smart phones.

4. The method and apparatus of claim 1 wherein said OTP generation means contains means to securely communicate with the said Global Authentication Server means for key exchange and subsequently for the key generation and displaying on the said mobile hand-held device.

5. The method and apparatus of claim 1 wherein said One-Touch button generates OTP after the button is pushed by the user when there is a demand for having a OTP for purposes containing authentication and identity assurance.

6. The method and apparatus of claim 1 wherein said One-Touch OTP generation means together with said Global Authentication Server means comprise an infrastructure to provide a Global Authentication Service for users to authenticate themselves to means contain means of web banking, Automated Teller Machines, financial transactions, or any business activity that requires authentication.

7. The method and apparatus of claim 1 wherein said Global Authentication Server offers Global Authentication Service means over means containing the Internet, Intranet, Wireless Network, phone, and other communication means.

8. The method and apparatus of claim 1 wherein said OTP generation means dynamically and independently computes non-static shared secret information that is the foundation to provide strong authentication.

9. The method and apparatus of claim 1 wherein said OTP generation means comprise means to generate OTP when there is no wireless connection. Under this situation, the OTP is generated by means which is a function of the current time and the non-static shared secret information which is generated and store at the hand-held device when there is a wireless connection.
